(19) United States
(12) Patent Application Publication
(10) Pub. No.: US 2021/0166065 A1
(43) Pub. Date: Jun. 3, 2021

(54) METHOD AND MACHINE READABLE STORAGE MEDIUM OF CLASSIFYING A NEAR SUN SKY IMAGE

(71) Applicant: Siemens Aktiengesellschaft, Muenchen (DE)

(72) Inventors: Ti-chiun Chang, Princeton Junction, NJ (US); Patrick Reeb, Adelsdorf (DE); Andrei Szabo, Ottobrunn (DE); Joachim Bamberger, Stockdorf (DE)

(21) Appl. No.: 17/251,911

(22) PCT Filed: Jun. 14, 2018
(86) PCT No.: PCT/EP2018/065777

§ 371 Date: Dec. 14, 2020

(51) Int. Cl. G06K 9/62; G06N 3/08; G06T 7/00; G06N 3/04

(52) U.S. Cl. CPC G06K 9/628; G06N 3/08; G06T 2207/20081; G06N 3/04; G06T 2207/20084; G06T 7/0002

(57) ABSTRACT

A method of classifying a near sun sky image includes at least one of the following steps: providing a recurrent neural network in the shape of a long short-term memory cell, the memory cell having at least an input gate, a neuron with a self-recurrent connection, a forget gate, and an output gate, and using a convolutional neural network, which includes, in the cited order, at least an input layer, one or more convolutional layers, an average pooling layer, and an output layer.

### FIELD OF INVENTION

The present invention relates to the field of photovoltaic. One of the most important factors that determine the stability and efficiency of a photovoltaic power station is the cloud coverage of the sunlight. Unfortunately, the cloud dynamics in a local area and within a short time horizon, such as 20 minutes, cannot be accurately predicted by any state-of-the-art computational model. A camera based system has the potential to fulfill the need by taking the sky pictures continuously every few seconds.

Work has been done with camera-based systems which provide potential for fulfilling cloud dynamics estimation. These systems capture images of the sky continuously over periodic intervals, for example, every few seconds. Through analysis of the time series of images a reasonable estimate of cloud trajectories may be obtained. Predictions of when and how much sunlight will be occluded in the near future may be made through the analysis.

The camera system is calibrated and the captured images are transformed into the physical space or their Cartesian coordinates, referred to as the sky space. The clouds captured in the images are segmented and their motion is estimated to predict the cloud occlusion of the sun. For cloud segmentation, algorithms based on support vector machine (SVM) and random forest have been proposed. To perform motion estimation, Kalman filtering, correlation and optical flow methods have been described in the literature. Techniques for long term predictions have been proposed, however, short term uncertainty is not addressed. A relatively short term (e.g. intra-hour) forecast confidence has been proposed correlating point trajectories with forecast error, with longer trajectory length corresponding to smaller forecast error. But using trajectory length as a criterion requires that the estimate be made only after the trajectory is completed. Thus, estimates at each image sample cannot be obtained.

To predict cloud coverage, image segmentation for cloud pixels is an essential step. Due to variations in sky conditions, different time of the day and of the year, etc., accurately identifying clouds in images is a very challenging task. A particular difficult but important area is that near the sun, when intensity saturation and optical artifacts (e.g. glare) are present. A classifier that is good in general may not work well for this area. In many cases, glares are mistakenly identified as clouds while most of the sky is clear.

### ART BACKGROUND

Most existing cloud segmentation techniques are based on color features, for example in S. Dev, Y. H. Lee, S. Winkler, “Color-based Segmentation of Sky/Cloud Images From Ground-based Cameras”, IEEE J. of Selected Topics in Applied Earth Observations and Remote Sensing, Vol. 10, No. 1, January 2017, pp 231-242.

However, the near sun area has pixel values close to saturation for all color channels and the color appearance of the clouds may be different from other areas in the image. In A. Heinle, A. Macke, and A. Srivastav, “Automatic Cloud Classification of Whole Sky Images”, Atmos. Meas. Tech., Vol. 3, May, 2010, pp 557-567, the sun position is used to mask out the sun area. This may not be effective or desirable because the glare artifacts can extend to such a large size that the prediction analytics becomes meaningless. It is also possible to re-classify the pixels based on motion information, which requires the cloud segmentation results. Not only does this become a chicken and egg problem, but also the motion information is not necessarily trust-worthy. In most cases, empirical parameters are needed to map these features into a decision which may be error prone. This is one of the approach experimented in our earlier development.

There may be a need for improved classification of a near sun sky image, i.e. of an image which is affected by the sun.

### SUMMARY OF THE INVENTION

This need may be met by the subject matters according to the independent claims. The present invention is further developed as set forth in the dependent claims.

According to a first aspect of the invention, there is provided a method of classifying a near sun sky image, the method comprising at least one of the steps of: using a recurrent neural network in the structure of a gated recurrent unit (GRU) or a long short-term memory cell (LSTM), which memory cell comprises at least an input gate, a neuron with a self-recurrent connection, a forget gate, and an output gate; and using a convolutional neural network (CNN), which network comprises, in this order, at least an input layer, one or more convolutional layers, an average pooling layer, and an output layer.

The classification can be realized by classifying whether an image patch is cloudy or not. An image patch is an example of an image and has a certain number of pixels.

To mitigate any misclassification, which leads to false alarm or miss detection in the prior art control systems, the method of the present invention classifies the near sun area as a clear sky or not. Further, the present invention can be designed in a software package that can be easily integrated into any existing cloud coverage prediction framework. Thereby, retrofitting of existing cloud coverage prediction framework is facilitated.

Advantageously, a convenient annotation mechanism is realized to perform supervised training based on robust training given noisy labels. This avoids intensively time consuming of human labor and still achieve high classification accuracy.

The obtained image patches do not show strong contrast (close to binary) as in digit patches in a conventional CNN according to the prior art, where a maximum pooling layer is usually used, the average pooling layer is devised in the convolutional neural network. Advantageously, the method according to the present invention is able to capture more subtle and likely smooth contrast.

The recurrent neural network further offers the capability to capture dynamic features such as motion. Advantageously, additional features can be extracted from the image dynamics to provide even better classification accuracy. The inputs to LSTM/GRU are a sequence of images and the outputs are a (delayed) sequence of class probabilities at the corresponding time instance.

If the recurrent neural network is used, the method preferably further comprises the steps of inputting a sequence of images of the sky near the sun into the input gate of the memory cell; processing the sequence of images in the neuron; and outputting a classification of the sequence of images of the sky near the sun from the output gate.

If the convolutional neural network is used, the method preferably further comprises the steps of inputting an image of the sky near the sun into the input layer of the convolutional neural network; processing the image in the convolutional neural network; and outputting a classification of the image of the sky near the sun from the output layer.

More preferred, both the recurrent neural network and the convolutional neural network can be used and the method preferably comprises a step of inputting a sequence of an output from the output layer of the convolutional neural network into the input gate of the recurrent neural network. The output from the output layer of the convolutional neural network, which is input into the input gate of the recurrent neural network, can be a one-dimensional vector.

Preferably, the convolutional neural network further comprises, between the average pooling layer and the output layer, at least one of a dropout layer, a flatten layer, and a dense layer. Particularly the dropout layer can accelerate the network training and avoid overfitting.

According to a second aspect of the invention, there is provided a machine readable storage medium containing stored program code that, when executed on a computer, causes the computer to perform a near sun sky image classification by accessing at least one of: a recurrent neural network in the shape of a gated recurrent unit (GRU) or a long short-term memory cell (LSTM), which memory cell comprises at least an input gate, a neuron with a self-recurrent connection, a forget gate, and an output gate; and a convolutional neural network, which network comprises, in this order, at least an input layer, one or more convolutional layers, an average pooling layer, and an output layer.

Here, the same advantages can be achieved like in the first aspect of the invention. In addition, the second aspect can be designed in a software package that can be easily integrated into any existing cloud coverage prediction framework. Thereby, retrofitting of existing cloud coverage prediction framework is facilitated.

The stored program code may be implemented as computer readable instruction code in any suitable programming language, such as, for example, JAVA, C++, and may be stored in the machine readable storage medium (removable disk, volatile or non-volatile memory, embedded memory/processor, etc.). The program code is operable to program a computer or any other programmable device to carry out the intended functions. The computer program may be available from a network, such as the World Wide Web, from which it may be downloaded.

According to a third aspect of the invention, there is provided an electric power system comprising a power grid; a photovoltaic power plant, which is electrically connected to the power grid for supplying electric power to the power grid; at least one further power plant, which is electrically connected to the power grid, for supplying electric power to the power grid and/or at least one electric consumer, which is connected to the power grid, for receiving electric power from the power grid; a control device for controlling an electric power flow between the at least one further power plant and the power grid and/or between the power grid and the at least one electric consumer; and a prediction device for producing a prediction signal being indicative for the intensity of sun radiation being captured by the photovoltaic power plant in the future; wherein the prediction device comprises a machine readable storage medium as set forth above, the prediction device is communicatively connected to the control device, and the control device is configured to control, based on the prediction signal, the electric power flow in the future.

The inventive electric power system is based on the idea that with a valid and precise prediction of the intensity of sun radiation, which can be captured by the photovoltaic power plant in the (near) future, the power, which can be supplied from the photovoltaic power plant to the power grid, can be predicted in a precise and reliable manner. This allows to control the operation of the at least one further power plant and/or of the at least one electric consumer in such a manner that the power flow to and the power flow from the power grid are balanced at least approximately. Hence, the stability of the power grid and, as a consequence also the stability of the entire electric power system can be increased.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this application.

### BRIEF DESCRIPTION OF THE DRAWINGS

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

FIG. 1 shows a network architecture of a convolutional neural network (CNN) in a first embodiment of the present invention;

FIG. 2 shows a network architecture of a short-term memory cell (LSTM) in a second embodiment of the present invention; and

FIG. 3 shows an electric power system comprising a grid and a periphery thereof.

### DETAILED DESCRIPTION

The illustrations in the drawings are schematically. It is noted that in different figures, similar or identical elements are provided with the same reference signs.

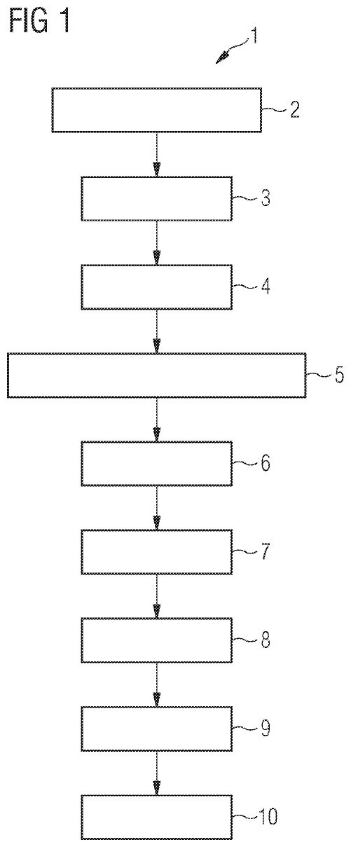

FIG. 1 shows a network architecture of a convolutional neural network (CNN) 1 which is used in a method of classifying a near sun sky image according to the first embodiment of the present invention.

The convolution neural network 1 is used for digit recognition. It is assumed that the convolutional neural network 1 is suitable trained beforehand. The training of the convolutional neural network 1 is sufficiently known in the state of the art and needs not further be described. An example of a conventional CNN is known from Y. LeCun, L. Bottou, Y. Bengio, and P. Haffner, “Gradient-based learning applied to document recognition”, Proceedings of the IEEE, November 1998.

The convolutional neural network 1 comprises, in this order, an input layer 2, two convolutional layers 3, 4, an average pooling layer 5, a dropout layer 6, a flatten layer 7, a dense layer 8, a dropout layer 9, a dense layer 10, and an output layer (not shown).

The convolutional layers 3, 4 comprise learnable filters having a small receptive field, but extend through the full depth of the input volume.

In the dropout layers 6, 9, a regularization is performed during the network training with the aim to reduce the network's complexity in order to prevent overfitting. For example, certain units (neurons) in a layer can randomly deactivated (or dropped) with a certain probability p for example from a Bernoulli distribution (typically 50% of the activations in a given layer are set to zero, while the remaining ones are scaled-up by a factor of 2). If half of the activations of a layer is set to zero, the neural network won't be able to rely on particular activations in a given feed-forward pass during training. Consequently, the neural network will learn different, redundant representations. At the end of the training, those units, which do not have substantial benefit, are permanently dropped from the network. Finally, if the training has finished, the complete network is usually tested, where the dropout probability is set to 0. Advantageously, training will be faster by the dropout layers 6, 9.

The dense layers 6, 9 and the flatten layer 7 are classifiers. In contrast to the dropout layers 6, 9, the dense layer 8 is simply a layer where each unit or neuron is connected to each neuron in the next layer. Like every classifier, the dense layer 8 needs individual features like a feature Vector. For this purpose, the multidimensional output must be converted into a one-dimensional vector, which is made by the flatten layer 7.

A particularity of the first embodiment is the use of the average pooling layer 5 instead of a maximum pooling layer. Maximum pooling is by far the most widespread method, whereby only the activity of the most active (hence “Max”) neuron is retained for further calculation steps from a submatrix of neurons of the convolutional layer, while the activity of the remaining neurons is discarded.

In contrast thereto, the first embodiment of the present invention uses the average pooling layer 5, whereby only the average in a submatrix of neurons of the convolutional layer is retained for further calculation steps, while the activity of the remaining neurons is discarded. The inventors of the present patent application found that, image patches including the near sun area do not show a strong contrast as in the digit patches of other images, the average pooling layer 5 is preferred. The average pooling layer 5 is able to capture more subtle and likely smooth contrast.

In a nutshell, the CNN network 1 functions as automatic filter design based on convolution operations (thus the name convolutional neural network 1) in the first two layers 2, 3 (except for the input layer 1) followed by layers of perceptrons 6 to 10, the last of which outputs class probabilities. Examples of conventional perceptrons can be found in F. Rosenblatt, The Perceptron—a perceiving and recognizing automaton. Report 85-460-1, Cornell Aeronautical Laboratory, 1957.

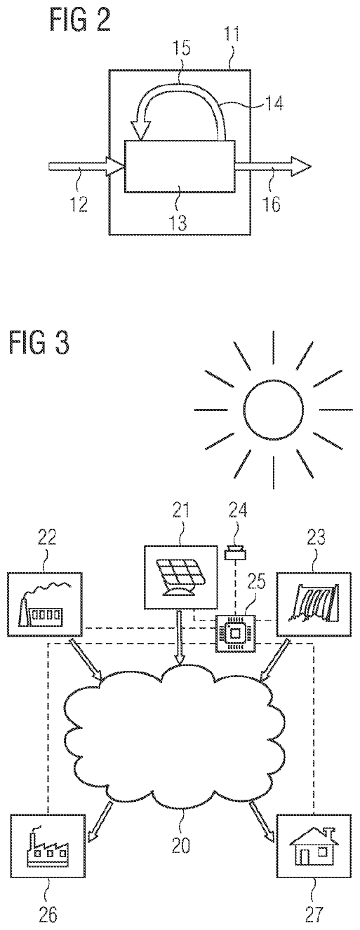

FIG. 2 shows a network architecture of a short-term memory cell (LSTM) in a second embodiment of the present invention. The second embodiment is a method of classifying a near sun sky image, the method comprising the steps of: using a long short-term memory cell 11, which memory cell 11 comprises at least: an input gate 12, a neuron 13 with a self-recurrent connection 14, a forget gate 15, and an output gate 16; inputting a sequence of images of the sky near the sun into the input gate 12 of the memory cell 11; processing the sequence of images in the neuron 13; and outputting a classification of the sequence of images of the sky near the sun from the output gate 16.

Instead of a single neural function in the LSTM, there are four modules that interact with each other in a very special way. An LSTM contains the input gate, the output gate and the forget gate and an inner cell in the shape of a neuron. In short, the input gate is the extent to which a new value flows into the cell, the forget gate is the extent to which a value remains or is forgotten in the cell, and the output gate is the extent to which the value in the cell is used for a calculation in a next module in the process. These network elements are connected with sigmoid neural functions and various vector and matrix operations and transferred into each other. The associated equations for each gate and how this network works are known in the state of the art so that there is no need for detailed descriptions. Associated equations for each gate and why this network can be powerful are also explained in S. Hochreiter and J. Schmidhuber (1997), “Long short-term memory”. Neural Computation. 9 (8): 1735-1780. doi:10.1162/neco.1997.9.8.1735.

The memory cell 11 can forget its state or not at each time step. For example, if a cloud's development is analyzed and it is determined that this development is not relevant for whatever reason, the memory cell 11 can be set to zero before the net ingests the first element of the next analysis.

The inventors found out that such a LSTM offers the capability to capture dynamic features such as motion. Advantageously, additional features can be extracted from the image dynamics to provide better classification accuracy. The inputs to LSTM are a sequence of images and the outputs are a (delayed) sequence of class probabilities at the corresponding time instance.

Advantageously, a convenient annotation mechanism is realized to perform supervised training based on robust training given noisy labels. This avoids intensively time consuming of human labor and still achieve high classification accuracy. Examples of such a robust training is for example given in D. Rolnick, A. Veit, S. Belongie, N. Shavit, “Deep Learning is Robust to Massive Label Noise”, https://arxiv.org/abs/1705.10694; D. Flatow and D. Penner, “On the Robustness of ConvNets to Training on Noisy Labels”, http://cs231n.stanford.edu/reports/flatow_ penner_report.pdf, 2017; and A. Vandat, “Toward Robustness against Label Noise in Training Deep Discriminative Neural Networks”, https://arxiv.org/abs/1706.00038.

The irradiance measurements can be made by a pyranometer, for example.

If in a period of time, for example 30 minutes, the irradiance follows the predicted clear sky index, then there is a good chance of clear sky in the middle of the 30 minutes, i.e., the 1.5^{th} minute, if a time counter is initiated from 0 every time. This is because there is time correspondence between the image patches and the measure irradiance. However, this alone might probably not guarantee the condition because clouds can move through and near the sun without covering it, thus resulting in no irradiance drop.

Therefore, the cloud segmentation algorithms of the present invention can be used as a supplementary criterion. A high threshold can be set to make sure that there is no identified cloud in the image patch to label it as “clear” (vs. cloudy). Combining the two criterions, nearly correct annotations can be achieved among all the labeled data. Optionally, schemes can be adopted to deal with noisy labels and thus improve the training accuracy. Examples of such schemes are known from S. E. Reed, H. Lee, D. Anguelov, C. Szegedy, D. Erhan, and A. Rabinovich, “TRAINING DEEP NEURAL NETWORKS ON NOISY LABELS WITH BOOTSTRAPPING”, workshop contribution at ICLR 2015; and A. J. Bekker, and J. Goldberger, “Training deep neural-networks based on unreliable labels”, Acoustics, Speech and Signal Processing (ICASSP), 2016 IEEE International

Conference on, 20-25 Mar. 2016, Shanghai, China.

The herein used term “image near the sun” covers an image including image parts, the characteristics thereof (for example brightness, contrast, color, etc.) are affected by the sun. The term particularly covers images, in which the sun is included.

The CNN and the LSTM are usually realized in a computer-implemented manner, i.e. their layers and/or modules are developed by software and stored in a machine readable storage medium. Training of the CNN and the LSTM is likewise performed in a computer-implemented manner. It is to be noted that the CNN and the LSTM need not to be physically implemented, for example by means of mechanical or structural devices.

The invention may be realized by means of a computer program respectively software. However, the invention may also be realized by means of one or more specific electronic circuits respectively hardware. Furthermore, the invention may also be realized in a hybrid form, i.e. in a combination of software modules and hardware modules.

The invention described in this document may also be realized in connection with a “CLOUD” network which provides the necessary virtual memory spaces and the necessary virtual computational power.

Comparing the CNN and the LSTM, the CNN is a type of a feed-forward artificial neural network with variations of multilayer perceptrons which are designed to use minimal amounts of preprocessing. The CNN uses connectivity pattern between its neurons. The CNN does usually not have a memory.

The LSTM does not follow the strict feed-forward nature and has the internal memory to process arbitrary sequences of inputs, and remember the features learned previously. The LSTM can handle arbitrary input/output lengths. Unlike feedforward neural networks, the LSTM can use its internal memory to process arbitrary sequences of inputs. LSTM uses recurrent time-series information, i.e. an output will impact the next input.

FIG. 3 shows an electric power system comprising a power grid 20 and a periphery thereof. The electric power system includes the photovoltaic power plant 21, which is electrically connected to the power grid 20 for supplying electric power to the power grid 20; at least one further power plant 22, 23, such as a conventional power plant such as a nuclear power plant (not shown), a coal-fired power plant 22, a hydroelectric power plant 23, or a windmill (not shown), which is electrically connected to the power grid 20, for supplying electric power to the power grid 20 and/or at least one electric consumer 26, 27, such as a factory 26 and/or a private consumer like a house 27, which is connected to the power grid 20, for receiving electric power from the power grid 20; a control device 25 for controlling an electric power flow between the at least one further power plant 22, 23 and the power grid 20 and/or between the power grid 20 and the at least one electric consumer 26, 27; and a prediction device (not shown) in the shape of a computer for producing a prediction signal being indicative for the intensity of sun radiation being captured by the photovoltaic power plant in the future.

The prediction device comprises a camera 24 for capturing near sun sky images. The near sun sky images will be forwarded to the data processor for processing the corresponding image data in the manner as described above.

The prediction device further comprises a machine readable storage medium which contains stored program code that, when executed on the computer, causes the computer to perform the near sun sky image classification according to the present invention as described above. The prediction device is communicatively connected to the control device 25, and the control device 25 is configured to control, based on the prediction signal, the electric power flow in the future.

The described electric power system is based on the idea that with a valid and precise prediction of the intensity of sun radiation, which can be captured by the photovoltaic power plant in the (near) future, the power, which can be supplied from the photovoltaic power plant to the power grid, can be predicted in a precise and reliable manner. This allows to control the operation of the at least one further power plant and/or of the at least one electric consumer in such a manner that the power flow to and the power flow from the power grid are balanced at least approximately. Hence, the stability of the power grid and, as a consequence also the stability of the entire electric power system can be increased.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

### LIST OF REFERENCE SIGNS

1 convolutional neural network (CNN)

2 input layer

3 convolutional layer

4 convolutional layer

5 average pooling layer

6 dropout layer

7 flatten layer

8 dense layer

9 dropout layer

10 dense layer

11 long short-term memory cell (LSTM)

12 input gate

13 neuron

14 self-recurrent connection

15 forget gate

16 output gate

20 power grid

21 photovoltaic plant

22 conventional power plant

23 hydroelectric power plant

24 camera

25 control unit

26 factory

27 house

1-11. (canceled)

12. A method of classifying a near sun sky image, the method comprising at least one of the steps of:
providing a recurrent neural network in the structure of a gated recurrent unit or a long short-term memory cell, which memory cell comprises at least an input gate, a neuron with a self-recurrent connection, a forget gate, and an output gate; and
providing a convolutional neural network, which network comprises, in this order, at least an input layer, one or more convolutional layers, an average pooling layer, and an output layer; and
using at least one of the recurrent neural network or the convolutional neural network to classify a near sun sky image.

13. The method according to claim 12, which comprises using the recurrent neural network to classify a near sun sky image and thereby:
inputting a sequence of images of the sky near the sun into the input gate of the memory cell;
processing the sequence of images in the neuron; and
outputting a classification of the sequence of images of the sky near the sun from the output gate.

14. The method according to claim 12, which comprises using the convolutional neural network to classify a near sun sky image and thereby:
inputting an image of the sky near the sun into the input layer of the convolutional neural network;
processing the image in the convolutional neural network; and
outputting a classification of the image of the sky near the sun from the output layer.

15. The method according to claim 12, which comprises using the recurrent neural network and the convolutional neural network to classify a near sun sky image and thereby:
inputting a sequence of an output from the output layer of the convolutional neural network into the input gate of the recurrent neural network.

16. The method according to claim 12, which comprises using the recurrent neural network and the convolutional neural network and thereby:
with the recurrent neural network:
inputting a sequence of images of the sky near the sun into the input gate of the memory cell;
processing the sequence of images in the neuron; and
outputting a classification of the sequence of images of the sky near the sun from the output gate; with the convolutional neural network:
inputting an image of the sky near the sun into the input layer of the convolutional neural network;
processing the image in the convolutional neural network; and
outputting a classification of the image of the sky near the sun from the output layer; and
inputting a sequence of an output from the output layer of the convolutional neural network into the input gate of the recurrent neural network.

17. The method according to claim 12, wherein the convolutional neural network further comprises, between the average pooling layer and the output layer, at least one of a dropout layer, a flatten layer, and a dense layer.

18. A machine-readable storage medium containing non-transitory stored program code which, when executed on a computer, causes the computer to perform a near sun sky image classification by accessing at least one of:
a recurrent neural network having a structure of a gated recurrent unit or a long short-term memory cell, the memory cell having at least an input gate, a neuron with a self-recurrent connection, a forget gate, and an output gate; and
a convolutional neural network, which includes, in the following order: at least an input layer, one or more convolutional layers, an average pooling layer, and an output layer.

19. The machine-readable storage medium according to claim 18, wherein the computer is prompted to perform the near sun sky image classification by accessing the recurrent neural network, and the stored program code, when executed on the computer, causes the computer to:
input a sequence of images of the sky near the sun into the input gate of the memory cell;
process the sequence of images in the neuron; and
output a classification of the sequence of images of the sky near the sun from the output gate.

20. The machine-readable storage medium according to claim 18, wherein the computer is prompted to perform the near sun sky image classification by accessing the convolutional neural network, and the stored program code, when executed on the computer, causes the computer to:
input an image of the sky near the sun into the input layer of the convolutional neural network;
process the image in the convolutional neural network; and
output a classification of the image of the sky near the sun from the output layer.

21. The machine-readable storage medium according to claim 18, wherein the computer is prompted to perform the near sun sky image classification by accessing both the convolutional neural network and the recurrent neural network, and the stored program code, when executed on the computer, causes the computer to input a sequence of an output from the output layer of the convolutional neural network into the input gate of the recurrent neural network.

22. The machine-readable storage medium according to claim 18, wherein the computer is prompted to perform the near sun sky image classification by accessing both the convolutional neural network and the recurrent neural network, and:
upon accessing the recurrent neural network, the stored program code causes the computer to:
input a sequence of images of the sky near the sun into the input gate of the memory cell;
process the sequence of images in the neuron; and
output a classification of the sequence of images of the sky near the sun from the output gate;
upon accessing the convolutional neural network, the stored program code causes the computer to:
input an image of the sky near the sun into the input layer of the convolutional neural network;
process the image in the convolutional neural network; and
output a classification of the image of the sky near the sun from the output layer;
input an image of the sky near the sun into the input layer of the convolutional neural network;
process the image in the convolutional neural network; and
output a classification of the image of the sky near the sun from the output layer;
input a sequence of an output from the output layer of the convolutional neural network into the input gate of the recurrent neural network.

23. The machine-readable storage medium according to claim 18, wherein the convolutional neural network further comprises, between the average pooling layer and the output layer, at least one of a dropout layer, a flatten layer, and a dense layer.

24. An electric power system, comprising:
a power grid;
a photovoltaic power plant, which is electrically connected to said power grid for supplying electric power to said power grid;
at least one further power plant electrically connected to said power grid, for supplying electric power to said power grid and/or at least one electric consumer connected to said power grid, for receiving electric power from said power grid;
a control device for controlling an electric power flow between said at least one further power plant and said power grid and/or between said power grid and said at least one electric consumer; and
said prediction device being communicatively connected to said control device; and
said control device being configured to control, based on the prediction signal, a future electric power flow.
